(19) United States
(12) Patent Application Publication
(10) Pub. No.: US 2023/0351492 A1
(43) Pub. Date: Nov. 2, 2023

(54) Systems and Methods for Determining an Interest Rate for a Transaction

(71) Applicant: Decameron Technologies LLC, New York, NY (US)

(72) Inventors: John C. Tsai, Los Altos Hills, CA (US); Ksenija A. McCormick, New York, NY (US)

(73) Assignee: Decameron Technologies LLC, New York, NY (US)

(21) Appl. No.: 17/730,556

(22) Filed: Apr. 27, 2022

(51) Int. Cl. G06Q 40/02; G06Q 30/02

(52) U.S. Cl. CPC G06Q 40/02; G06Q 30/0283

(57) ABSTRACT

A system and methods for determining a short-term interest rate for use in financial transactions. The determined rate may be used as a standard or baseline to which other rates are pegged. The described process may be used to generate a short-term rate that is a more accurate reflection of market transactions than the substitutes for Libor being considered. The described process may also be used to generate term-specific short-term rates and rates based on transactions involving entities having a specific credit rating. These capabilities result in a more reliable short-term rate and one that may be made specific to certain classes of participants in a transaction.

### BACKGROUND

This application includes the attached Appendix, which contains information that may provide further examples and/or details regarding one or more embodiments of the disclosure described herein. The entire contents of the Appendix are considered part of the present application and are incorporated herein in their entirety.

Many transactions involve a transfer of funds. These include mortgages, loans, investments, etc. In many of these situations, the transfer is accompanied by an interest rate that determines how much must be paid or repaid to the source of the funds. In some cases, the interest rate may be set based on its relationship to a standard or index rate; for example, for a specific transaction the interest rate may be set at a certain amount above a standard rate.

One of the commonly used standard rates is the London Inter-bank Offered Rate (referred to as “LIBOR”). The London Inter-bank Offered Rate is an interest-rate average calculated from estimates submitted by the leading banks in London. Each bank estimates what it would be charged were it to borrow from other banks. Libor serves as the primary benchmark, along with the Euribor, for short-term interest rates around the world. Libor rates are calculated for five currencies and seven borrowing periods ranging from a term of overnight to one year and are published each business day by Thomson Reuters. Many financial institutions, mortgage lenders, and credit card agencies set their own interest rates relative to Libor. It is estimated that at least $350 trillion in derivatives and other financial products are tied to Libor in one form or another.

However, due to evidence of manipulation by banks, the use of Libor was phased out at the end of 2021, and market participants are being encouraged to transition to other reference rates. Because Libor is used in US derivatives markets, an attempt to manipulate Libor is an attempt to manipulate US derivatives markets, and thus a violation of American law. Since mortgages, student loans, financial derivatives, and other financial products often rely on Libor as a reference rate, the manipulation of data used to determine Libor is likely to have had significant and negative effects on consumers and financial markets worldwide.

Although several replacement rates have been suggested (including SOFR, the Secured Overnight Financing Rate, and rates suggested by private enterprise, such as Ameribor, AXI, and BSBY), each has shortcomings for certain types of market participants and during periods of heightened market volatility.

SOFR is generated using a volume-weighted average of daily transactions in the overnight Treasury repurchase market. Concerns about using SOFR include the lack of a credit component and exposure to the idiosyncratic movements of the repurchase market. Other proposed methodologies generate a short-term rate by using an average of rates in a region of a rate curve. This may be satisfactory at times, but during periods of duress (volatility) in the markets, not enough data may be available to provide a reliable average. For instance, Ameribor is based on a relatively small amount of transaction volume and may not reflect a reliable rate. Although BSBY attempts to cure the concern created by limited transaction volume, it does so by using a backwards-looking averaging method that may introduce other assumptions or errors.

Therefore, it is a distinct possibility that none of the existing proposed short rate substitutes may become a universally accepted standard in the way that Libor was in its heyday. Unfortunately, this means that there is a likelihood that unless some other benchmark rate is proposed and widely adopted, the market for the benchmark short rate in the US could become fractured and anarchic. This would lead to increased uncertainty in financial transactions, resulting in increased volatility and costs for consumers and businesses.

Embodiments of the systems and methods described herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter described in this document, the drawings or figures, and to the claims. Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to systems and methods for determining a short-term interest rate for use in financial transactions. The determined rate may be used as a standard or baseline to which other rates are pegged (i.e., the other rates are set in relation to the generated rate). The described process may be used to generate a short-term rate that is a more accurate reflection of market transactions than the substitutes for Libor being considered. The described process may also be used to generate term-specific short-term rates and rates based on transactions involving entities having a specific credit rating. These capabilities result in a more reliable short-term rate and one that may be made specific to certain classes of participants in a transaction.

In one embodiment, the disclosure is directed to a method for determining a short-term interest rate for use in financial transactions. In one embodiment, the method may include the following steps, stages, functions, processes, or operations:
Define a rate curve (e.g., a corporate yield curve) as the sum of two contributing parts:
   A risk-free rate curve or function; and
   A (corporate) spread to the risk-free rates determined by the curve or function;
Generate a risk-free rate curve or function;
   In some embodiments, this is a yield curve model for risk free rates, either for high grade sovereign rates (e.g., US Treasuries) or Interest Rate swaps;
      A two and a half factor stochastic arbitrage free short rate model may be used;
      Other short rate models that are appropriate for the given purpose or context may be used;
Generate a model for the (corporate) spread to the risk-free rates of the risk-free curve or function;
   Incorporate representation of short-term default risk and long-term default risk into model;
      Model long-term default risk as stochastic Poisson transition to default with three parameters;
         the instantaneous probability of default;
         the lag to recovery; and
         the amount of recovery;
      Model short-term default risk as an initial instantaneous probability of default, with an exponential decline over time in accordance with a decay time—this model contains four parameters;
         the initial probability of default;
         the decay rate of the probability;
         the lag to recovery; and
         the amount of recovery;
Implementation and Use Cases
   Investment Grade
      Collect or acquire data needed to fit (corporate) spread to the risk-free rates;
         Filter data as needed to that relevant to desired type or class of corporate bond for which the rate (corporate yield) curve is being generated (e.g., A, etc.);
         Data should be collected for all maturities and then filtered for trade size, or other indicia of unreliability (small sample size, etc.);
      Adjust the three long-term default model parameters to fit actual observed data;
   High Yield;
      Collect or acquire data needed to fit (corporate) spread to the risk-free rates;
         Filter data as needed to that relevant to desired type or class of corporate bond for which the rate (corporate yield) curve is being generated (e.g., BBB, etc.);
         Data should be collected for all maturities and then filtered for trade size, etc.;
      Adjust the three long-term default model parameters to fit actual observed data;
      If possible, adjust the four short-term default model parameters to fit actual observed data;
Based on the risk-free rate curve or function and the determined spread to the risk-free rates, determine or generate the rate (corporate yield) curve;
   Using the determined rate (corporate yield) curve, determine the desired short-term interest rate based on the desired maturity period.

In one embodiment, the disclosure is directed to a system for determining a short-term interest rate for use in financial transactions. The system may include a set of computer-executable instructions and a processor or co-processors. When executed by the processor or co-processors, the instructions cause the processor or co-processors (or a device of which they are part) to perform a set of operations that implement an embodiment of the disclosed method or methods.

In one embodiment, the disclosure is directed to a set of computer-executable instructions, wherein when the set of instructions are executed by a processor or co-processors, the processor or co-processors (or a device of which they are part) perform a set of operations that implement an embodiment of the disclosed method or methods.

In some embodiments, the systems and methods described herein may provide an ability to determine a rate or corporate yield curve and select a desired short-term interest rate through a Software-as-a-Service (SaaS) or multi-tenant platform. The platform provides access to multiple users (such as a financial organization), each with a separate account and associated data storage. Each user account may correspond to a source of transactions, a participant in a transaction, or an organization, for example. Each account may access one or more services, an example of which are instantiated in their account, and which implement one or more of the methods or functions described.

As examples of uses of the described approach for generating a short-term rate, futures contracts using the rate can be constructed in the same way Eurodollar futures are futures associated with LIBOR. Swaps can be constructed so that the cash flows of the floating side are determined by the new rate, just as most swap transactions in the past were determined at least in part based on LIBOR. Further, the described rate can be used to determine cash flows for floating rate notes, floating rate bonds (and asset backed bonds), and securitized and non-securitized loans, similarly to how LIBOR was used in the past. Cash flows for mortgage securities, both in the US and internationally, and for residential and commercial properties, can also be determined based on the generated short rate, similarly to the way LIBOR was used previously. In some embodiments, each use of the methodology described herein to generate a short-term rate for a transaction may generate an associated fee, either on a per use basis (fixed or based on transaction size) or on an ongoing licensing basis.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1 is a flowchart or flow diagram illustrating a method, process, operation, or function for determining a short-term interest rate, in accordance with some embodiments;

FIG. 2 is a diagram illustrating elements or components that may be present in a computer device, server, or system configured to implement a method, process, function, or operation in accordance with some embodiments of the invention; and

FIGS. 3-5 are diagrams illustrating an architecture for a multi-tenant or SaaS platform that may be used in implementing some embodiments of the systems and methods described herein.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, there are several proposed replacements for Libor as a short-term rate baseline, although each has important limitations or disadvantages. These proposed replacements are discussed below in greater detail as a further way of illustrating the benefits and advantages of the disclosed approach.

At present, there are several existing short rate proposals being considered for adoption. One has the apparent backing of regulators, but does not have widespread industry backing, while others are fully private, and do not have widespread industry backing. These examples are described in the following.

SOFR (Securitized Overnight Funding Rate): This rate is computed by the NY Fed and is taken as the volume weighted median rate of repurchase transactions collateralized by US Treasuries in three specific markets. These include the tri-party repurchase market, the General Collateral Finance market, and bilateral repurchase transactions cleared through FICC's DVP Service. Intuitively, SOFR can be thought of as a broadly based measure of the overnight rate of Treasury Repurchases. This rate is computed daily and, as of now, only an overnight rate is computed. Of note, transactions done through the NY Fed's repurchase facility are specifically excluded from the averaging.
The idea is that SOFR is intended to be a fully “market” determined rate. Repurchase transactions at the Fed are being facilitated as part of the Fed′: mandate to regulate short term policy rates (a different set of rates than LIBOR), so are not thought to constitute fully arm's length, free market, transactions. Because SOFR was developed in concert with regulators and is computed by the NY Fed, various statements and actions by the Fed appear to indicate that this is the LIBOR replacement that would be preferred by regulatory bodies.
   SOFR has not been universally adopted by markets and there has been pushback from the wider financial community. This occurred for several reasons, but most importantly because SOFR is based on US Treasury repurchase transactions. As such, it does not have the same exposure to corporate credit as the original LIBOR rate. In addition, historical data shows that LIBOR and SOFR are very different measures and do not track each other or vary in the same way or in accordance with the same factors. As observed, the two rates can move largely independently of each other. Thus, the concerns about using SOFR include the lack of a credit component and exposure to the idiosyncratic movements of the repurchase market.

For example, LIBOR can increase substantially (due to a credit crisis), while at the same time there are no disruptions in repurchase markets, so SOFR remains unchanged. Conversely, a funding squeeze in Treasury markets can cause SOFR to expand in the absence of a credit event, in which case LIBOR would remain unchanged. Because SOFR lacks the credit exposure of LIBOR, it may not be suitable or applicable as a replacement for all the situations for which LIBOR was employed. If SOFR were to be widely adopted, there would be an absence of a short rate that has any real exposure to credit, since the other widely adopted short rate, the Fed Funds rate that is set by the Open Markets Committee of the US Federal Reserve, does not have any measure of credit exposure. It is believed that this the primary reason for market pushback on adopting the SOFR rate.

Ameribor (American Interbank Offered Rate): The idea behind this proposed rate is to preserve the methodology of LIBOR but attempt to repair the shortcomings of the process of determining the rate. For reference, LIBOR was determined in the following manner: a set of “reporting” banks would report daily what they would charge other banks to borrow from them. The LIBOR benchmarks were then determined by throwing out the highest and lowest reported rates, and then averaging the remaining ones. Potential problems with this method of setting a rate included: (a) the illegal and opaque manipulation of reported rates by individual banks for their individual benefit, which led to widespread legal and operational difficulties for both the banks involved and for the LIBOR determination process itself; and (b) insufficient volumes of actual borrowing transactions to accurately determine an average market rate. In this situation, banks resorted to reporting “expertly” determined rates, which were simply what the given bank thought it would charge other banks to borrow from it if borrowing were to happen.

Ameribor is the transaction volume weighted average interest rate of daily transactions in the Ameribor overnight unsecured loan market. Members of this loan market report their transactions for averaging purposes. Similar to LIBOR, Ameribor is a representation of unsecured borrowing by corporate entities that are subject to default risk. Ameribor, therefore, is a rate that contains credit risk and is based on a relatively small amount of transaction volume. It gets around the issue of manipulation because the averaging is limited to actual transactions that are reported transparently in the market and it gets around the issue of insufficient transaction volume by including a large set of reporting members in the Ameribor loan market. In contrast, there are believed to be approximately 12 (or fewer) reporting banks used to determine LIBOR.

While preferable to LIBOR in some respects, there is a serious drawback with Ameribor; by vastly expanding the set of reporting members relative to that of LIBOR, the set of members are very disparate in terms of credit quality. Therefore, depending upon which set of members' trades are represented in the market at any given time, the resulting averaged rate can oscillate between a rate for high credit quality to a rate that reflects low credit quality, and this may occur in rapid succession and at random. As an example, it could be the case that on one day, most trading is done by high credit quality members and the next day most of the trading is done by low credit quality borrowers. Therefore, even if interest rates do not move, the Ameribor rate can oscillate wildly from one day to the next for no reason except the randomness of the sampling performed in setting the rate. This potential problem is causing the market concern in terms of adoption of the rate.

BSBY (Bloomberg Short-Term Bank Yield Index): This is the Bloomberg short rate candidate to replace LIBOR. The data set used to determine this rate are the commercial paper (CP), certificate of deposit (CD), and corporate bond (CB) trades that are executed using the Bloomberg electronic trading system. While all CB trades are reported on the TRACE system run by FINRA, CP trades need not be reported. Therefore, at least the CP part of the index represents a proprietary data set that is not necessarily available to be reviewed in general. Also, because the data are restricted to those trades occurring on the Bloomberg system, it represents a subset of all trades in the market on any given day and may not reflect a truly representative sample of trades. As a result, concerns about using BSBY include the relatively small transaction volume and the backwards-looking averaging method employed to compensate for that shortcoming.

BSBY is defined for several different maturities starting from overnight up to 1.2-month maturities. Primarily using trades at short maturities and a three-day rolling window, a curve is fitted through the data to imply the “average” rates at the appropriate maturity period. These are then published as the BSBY rates. In this sense, BSBY is an averaged credit rate of some kind.

However, this approach (BSBY) has several important disadvantages:
Firstly, because the data are from a rolling window in dates, BSBY rates do not reflect what happens in each day, but over a period of several days. This is not expected to be a significant source of error when markets are not volatile, since the average over three days that show low volatility provides a reliable representation of each day in the period. However, when markets are volatile, each of the three days may be very different, so an averaging will give a poor representation of a specific day. The reason BSBY uses an average over three days is to try to ensure that there is sufficient data over which to compute an accurate average;
Secondly, in certain situations, such as when there is not sufficient data to generate a good curve, BSBY would again defer to expert opinion to provide rates. This would potentially have the same difficulties that arose before in the setting of LIBOR. However, this provision was recently flagged by UK regulators as a problem and was removed. In the future, there will not be the possibility of incorporating expert opinion;
Thirdly, while this index is fitting a curve to the trade data, the fit is only over the part of the curve from overnight to one year. Therefore, there is very little difference between implying a rate from this type of curve fitting and simply collecting the traded yields and averaging them. That is, there is no essential difference between fitting a curve and doing an arithmetic averaging of the yields, in this case, curve fitting adds little to the process and is almost a superfluous part of the methodology because the fitting is limited to the region of overnight to one year maturity¹, and ¹As background, in cases where there is sufficient data across the curve, fitting a curve will give a similar answer to averaging over a small window in maturity. As an example, consider a fixed maturity point, in this case the 1-year point. If there is sufficient data clustered around the 1-year point, then a curve that goes through the 1-year point will be fit through the cluster of points at a value that represents the average point value. Therefore, whether one averages points in a very tight maturity window around the 1-year point or whether one fits a curve through it is generally immaterial when there is sufficient data. In reality, fitting a curve to the entire maturity range in the situation of having sufficient trading data that is spaced across the curve is essentially simultaneously “averaging” all of the maturity points at the same time.A value of curve fitting is realized when there is insufficient data available. In this regard, the disclosed approach fits a curve to the entire range of maturity terms, thereby permitting all points along the curve to determine (together with the dynamics imbued to the curve by the disclosed model) the fitted points at shorter maturities. The fitted points that result are different from performing an averaging operation. Averaging in the situations addressed by the disclosed approach would either be infeasible because there are no points in a tight window about the maturity point in question, or there are so few that averaging in a tight window gives a spurious answer as compared to letting the entire curve dictate the result.The proposed approach differs from that of Bloomberg (BSBY) because the Bloomberg approach does not fit across the whole curve for its short end rates. Instead, they fit only the front points. This can give spurious results if there are only a few points to fit to because there is little information from these front-end points on the general shape of the curve. In contrast, if all points along a curve are considered, together with the dynamics of the disclosed interest rate model, then there is a more reliable determination of the front-end rates. As mentioned, in a situation where there is not enough data to do a front-end fit, conventional approaches appeal to an “expert's” opinion which may introduce bias or other forms of error. This situation is not expected to occur when using the disclosed approach, as it uses data points across the entire range of maturities, of which there will typically be enough, even in periods of distress, because the disclosed approach is using data regarding highly rated assets.
Fourthly, another difficulty is that Bloomberg presently has a dominant market position in global fixed income analytics and data (including indexes, etc.). Because of this, market participants are reluctant to rely on yet another Bloomberg product, which Bloomberg may exploit for its own profitability.

As discussed, the three major existing proposed LIBOR replacements have seen limited adoption by market participants, for one or more of the reasons mentioned, if newer, better solutions do not come to market, it is entirely possible that no single one of the existing proposed substitutes will become a universally accepted standard in the way that LIBOR was in its heyday. This may cause the market to become fractured and inconsistent, with negative consequences for traders and those seeking to engage in transactions.

In the following discussion, a corporate yield curve is a measurement of the expected return on investment for corporate bonds over time. The return is a function of (i.e., dependent upon) both the interest rates offered to investors buying the bonds and the amount of time the bonds are held, referred to as their maturity (or maturity period).

In some embodiments, the disclosed methodology generates a short-term interest rate based on a model in which a baseline yield curve (termed the risk-free rate curve herein) is adjusted by a spread to obtain a rate or in this case, a corporate yield curve. That is, in some embodiments, the corporate yield curve is defined as:

Corporate Yield curve=(Risk Free Rate curve)+(Corporate Spread to Risk Free Rate)

A goal of the methodology is to generate a reliable corporate yield curve by modeling the corporate spread (or change) to a risk-free rate curve.

In some embodiments, instead of a corporate yield curve, a different type or form of rate curve may be generated. In such cases, the desired curve (examples of which are described herein) may be defined as the sum of a baseline curve obtained from specific trade data and a spread or modification to the baseline curve modeled on sampled data. In some embodiments, the spread or modification may take the form of a function that exhibits behavior in accordance with the observed or expected behavior for a relationship expressed by the curve (such as exponential growth or decay, reaching a threshold, leveling off, splitting, etc.). The behavior may be based on general economic principles and/or on the economic characteristics of a source of the trade or sampled data (such as credit risk, inflationary pressures, outstanding debt, etc.).

The default models (either long term alone, or long term and short term) are usable as a framework for defining benchmark rates and curves for almost any instance in which default is a possibility. Thus, beyond US corporate curves, these situations may include (although the following is not intended to be an exhaustive list):
international corporates;
sovereign credit for countries that are not deemed of the highest quality (such as the top-rated countries). These can include highly rated countries, such as those rated A+, so only long-term default would be important for the model. This may also include less highly rated countries, such as those rated BB, in which case short term default would also be a possibility;
other governmental or sovereign debt, such as State, Provincial, etc.; or
supranational debt, such as issued by the World Bank, or other development bank.

Generating a Risk-Free Rate Curve:

This is a yield curve model for risk-free rates. These rates are rates that apply to situations where there is no default, that is, where there is absolute certainty that all contractually obligated cash flows will occur as scheduled. Risk free rates are not adjusted for any specific corporate bond characteristics. The risk-free rate model, therefore, is typically either for high grade sovereign rates (e.g., US Treasuries) or US Interest Rate swaps (because these are now generally cleared at a central clearing house facility, so there is no counterparty risk). In some embodiments, this baseline curve may be generated from a different data source.

In one embodiment, the disclosed system and method uses a model that is based on a two and a half factor stochastic arbitrage free short rate model, although other viable and satisfactory interest rate models could be used to capture the structure of risk-free rates, including public models such as the Hull White model, HJM, etc. In general, if the underlying model adequately captures the risk-free yield curve, it can be used as a basis for the disclosed corporate spread curve.

The specific risk-free interest rate model disclosed herein (the “two and a half factor stochastic arbitrage free short rate model”) is desirable to use for determining interest rates because it replicates the shape of actual risk-free yield curves and moves over time in the way that yield curves move, that is, it demonstrates the dynamic behavior of actual yield curves. These two properties combined imply that the two and a half factor model can replicate the properties and behaviors of actual yield curves.

This desirable behavior is in contrast with the behavior of splines, interpolation-based models, or stochastic models with fewer than two and a half factors, as described in the document titled “General Principles of Financial Model Construction”, which is contained in the Appendix and incorporated in its entirety into the application. Although a stochastic multifactor model that has greater than two and a half factors may also display the desired properties, such a model may suffer from a flaw that makes it equally unwieldy for use in real world financial applications. This flaw is that the model behavior often becomes too complicated and unwieldy to be understandable in simple intuitive terms, and changes in the model cannot be easily ascribed to underlying economic factors due to the complexity of the model.

In addition, the disclosed version of a two and a half factor model is designed such that the factors have simple economic interpretations. In some embodiments, one factor captures the long-term equilibrium behavior of rates as the compounding of overnight rates, incorporating a constant rate of volatility in rates. This is a simple and natural way to view long term interest rates. Note that if the short rate (i.e., the overnight rate) were to (hypothetically) stay the same over time, then a longer-term rate would be determined by the short rate compounded for the term of the longer-term rate. In this case, the longer-term term rate would then be an exponential function of the length of the term times the short rate. However, if the short rate were to vary over time, then the longer-term rate will increase at a faster pace than an exponential function of the term. In this case, there would be an additional factor that incorporates the rate volatility and would make the longer-term rate increase faster as a function of the term of the rate. In some embodiments, the model for the long-term equilibrium rate behaves in this manner.

A second factor captures intermediate term deviations from this long-term equilibrium that may be due to specific medium term affects in the markets. These deviations are characterized by a second independent volatility and a rate of decay back to the long-term equilibrium level. Again, this is a relatively simple and natural formulation of the behavior.

A third factor (the “half” factor) characterizes short-term deviations from the medium-term profile of rates. This short-term deviation, in turn, decays to the intermediate term profile over some timescale, which again is a simple and economically motivated formulation of short-term deviations from medium term characteristics.

Generating a Corporate Spread to Risk-Free Rates:

The (corporate) spread model provides the spread of a given rate or corporate yield curve with reference to the risk-free curve (i.e., the spread model represents a modification to the baseline risk-free curve). The model assumes that there are two types of default risk, a short-term default risk and a longer-term default risk:
A corporate entity that is not experiencing short-term distress is assumed to only be subject to the possibility of long-term default. This component is a general possibility for corporate entities because there is almost always the possibility that some issue may arise that causes a default
   Because the probability of default gradually accumulates over time, the cumulative probability of default increases monotonically with time. Because investors must be compensated for this, the resulting spread to risk free rates must gradually and monotonically rise for longer maturities. This situation generally characterizes investment grade credit;
In contrast, a corporate entity that is subject to an existing credit risk event will be subject to the possibility of both short-term default and long-term default. The existing stress on the entity implies that default could be imminent, in which case the spread to risk-free rates is elevated in the short-term. If the entity survives and the near-term credit duress is cured, then it will no longer be subject to short-term default and only to the possibility of long-term default.
   Based on this expected behavior, the spread should gradually migrate back to that which would exist if only long-term default were a possibility. Therefore, the spread should be elevated at the short end of the curve, then gradually migrate to a curve that gradually rises at longer maturities. This situation generally characterizes High Yield entities.

As in the case of the yield curve of risk-free rates, the above represents a relatively simple and natural formulation of a corporate curve model because it basically replicates what happens economically in the plurality of such circumstances (i.e., either short- or long-term default). This type of model also replicates the shape of actual corporate curves, is imbued with the same dynamics of actual corporate curves and has simple economically motivated factors.

When modelling other forms of investments or transactions (i.e., different than a corporate yield rate curve), the form of the resulting curve, the baseline risk-free curve, the components of the spread to the risk-free curve, etc. may differ from those described for the corporate yield curve based on the expected economic behavior of the spread components, the data used to produce the risk-free model, etc.

Long-Term Default Modelling:

The model assumes that there is a constant instantaneous probability of default for each time step. Mathematically, this is a stochastic Poisson jump to a default condition. In the event of default, after a lag period, there will be a recovery of some amount. In some embodiments, this model is characterized by three parameters; (i) the instantaneous probability of default, (ii) the lag to recovery, and (iii) the amount of recovery. The long-term default model is incorporated into a set of forward cash flow calculations to compute the model implied spread to the risk-free rate. Because the use case of the corporate yield curve is to determine a short rate benchmark, and because these benchmarks are likely to be restricted to highly rated situations, it will usually be the case that long-term default is the only component that will be of concern.

As an example, consider the case where there is no default. In this situation, the cash flows of a bond are determined as follows: a bond with a fixed coupon will have cash flows which are just these coupons, at the appropriate times in the future. This includes the repayment of the principal at the maturity of the bond. Each cash flow is discounted to the present to compute the present value of that cash flow (again including the cash flow of the repayment of the principal). The present values are added to give the total present value of all the cash flows. This is the “theoretical price” of the bond for the specific amount of discounting that was applied to the cash flows.

The theoretical price changes as the amount of discounting changes. The amount of discounting can be changed until the “theoretical price” equals the actual trading or market price of the bond in the market. This fixes the amount of discounting that is required to make the bond “fair” to the market, by making the computed theoretical price equal to the market price. When this procedure is repeated for a collection of similar bonds (for example, all US treasury bonds), the discounting is specified across all maturities. Since a discount factor is equivalent to specifying a discounting interest rate, the specification of discounting across a distribution of maturities is equivalent to specifying a “discount curve.” This discounting curve is the yield curve.

Now consider the case where there is the possibility of a default on at least some of the cash flows. This is a “corporate” curve. The corporate curve is computed the same way as the yield curve in the case of no default, except the cash flows are not fixed. A corporate bond that has a fixed coupon rate would have fixed, known coupons that are paid out at known times if it does not default. This case is analogous to a US treasury security.

However, each cash flow comes with a probability of a default event, and then subsequently having a recovery. So, there are two “branches” of possible outcomes to consider. In one set of cases, each cash flow pays out as scheduled. In the other, the cash flow does not pay out as scheduled because of a default. In addition, there is a chance the principal is not paid. Therefore, the forward going cash flows are effectively reduced relative to the case where there is no default. The amount by which they are reduced is determined by the three factors associated with default: the instantaneous probability of default, the lag, and the recovery. So, these three factors are adjusted until the “theoretical price” that is computed by discounting the default adjusted cash flows equals the market price. Again, this procedure is done for the basket of bonds that have been selected for the fitting process. This is how the three factors of the long-term default model translate into cash flows and then into a corporate curve.

Short-Term Default Modelling:

This component of the model assumes that there is some starting instantaneous probability of default, but this probability declines as time goes on, consistent with the notion that this is an immediate and short-term effect. The decline in the probability is exponential, with a given decay time. Thus, this is a stochastic Poisson jump to a default condition, with a decreasing default probability. As in the long-term case, in the event of default, there will be a recovery of some amount after a time lag. Therefore, this model is characterized by four parameters; (i) the initial probability of default, (ii) the decay rate of the probability, (iii) the lag to recovery, and (iv) the amount of recovery. This default is incorporated into a standard set of forward cash flow calculations to compute the model implied spread to the risk-free rate, in accordance with the process flow described previously, with the difference being that the factors associated with short term default are also adjusted to reach the objective.

Given the descriptions of the short-term and long-term default models and the definition of the corporate yield curve, the implementation of the data processing flow to obtain the risk-free baseline curve and the corporate spread to that curve may be described as follows.

Methodology Implementation (Investment Grade):

As a general example, in some embodiments, the steps required to construct a corporate yield curve are as follows:
The yield curve of risk-free rates is determined based either on interest rate swap data or sovereign bond data (US Treasuries or US interest rate swaps in the case of the US); The trade data that are to be used for fitting the corporate spread curve are collected.
This data may be subject to whatever filters are designated for the specific case. For example, if the curve is intended to represent US single A rated financials (i.e., rated A- to A+), then trades in securities of the subject entities of all maturities are first selected. Additional filters may be imposed on the trade data, such as trade sizes not being too small (could be off market) or too big (again, could be off market);
The three parameters of the long-term default model are adjusted (set, selected, determined, etc.) so that the model implied theoretical yields on the traded bonds match the actual observed trade yields as closely as possible;
   The closeness may be evaluated using a least squares metric—each term is the square of the difference between the market price of a transaction that is observed, and the theoretical price computed for the bond. The least squares will be minimized when this sum of terms is as small as possible;
   Note that since there are three parameters to the model, a minimum of three data points that are well spread out across maturity values are required to determine the default model. In practical terms, there will usually be more than three data points, but this specifies a minimum threshold requirement;
   When there are many data points, the optimization of the model (i.e., the selection of the parameters) will be on a least-squares basis, as is the case in an over-specified model—that is, there are many data points to fit, but only 3 parameters that can be adjusted, so the model cannot go exactly through each point; therefore, the “best” fit is the model that does the best at fitting the data points on average in accordance with a specified metric (e.g., least squares).

From the standpoint of short rate benchmark determination, since a minimum of three data points are required to determine the curve, and since there will usually be at least this number of data points to draw from, even during times of duress, it is expected that there will be no need to appeal to a “fall back” situation when there is insufficient data (such as an appeal to “expert” opinion). There is a presumption that at least some investment grade credit will always trade, such as would be the case with US Treasury securities, or equivalently, Gilts, Bunds, or JGBs.

Methodology Implementation (High Yield):
The risk-free yield curve is determined;
The trade data is collected;
In this case, there are a total of 7 model parameters that are set or determined by the data, 4 from for the short-term default model and 3 for the long-term default model. In practical terms, most transactions in high yield securities are of short to medium maturity, with few trades of long maturity. Therefore, the 4 parameters associated with the short-term default model will be better determined than the parameters of the long-term default model. This does not present a difficulty if the corporate yield curve is only relied upon for the shorter maturity period part of the yield curve, as would generally be the case for high yield trades or transactions. The short-term default component is dominant in determining this part of the curve since it is responsible for most of the spread to risk free rates at the short end of the maturity period;
   Therefore, it is relatively immaterial that there are uncertainties associated with the long-term component. This implies that there are typically only 4 fitting parameters, requiring a minimum of 4 data points to unambiguously specify the model. This will generally be the case, but it cannot be presumed that during periods of market duress that there can be any trading in high yield assets at all;
   This stands in contrast to what is assumed in the case of investment grade credit. Therefore, it is possible that the high yield curve cannot always be determined, even in the situation of requiring data for only 4 traded points;
      As a result, if a short rate benchmark is to be determined for the case of high yield, it is likely that there will have to be a fall-back recourse in the event of insufficient trade data.

As mentioned, the Appendix to this application, which is incorporated fully and for all purposes, discusses desired characteristics of a yield curve model and the importance of such a model behaving in a manner that is compatible with observed behaviors.

A Proposed Use Case of the Rate or Corporate Yield Curve Model:

Once the corporate model curve is specified, a type of rate, whether spot, term, forward, or future can be computed/determined using the curve. Given this, it is then possible to use the inferred rates for any purpose or transaction for which it may be needed.

As an example, a “curve” which is a plot of the instantaneous forward rates as a function of time is constructed. Thus, the base corporate curve is essentially the curve of corporate forwards. If one is interested in the instantaneous forward rate at 10-year maturity, then this value can be obtained from the base curve. However, in the case of the short rate benchmark calculation, what is important is not this forward rate, but a spot term rate. Assume one wants to compute a spot 3-month term rate. For this scenario, one would take the base curve of forward rates and compound the first 3 months' worth of rates to arrive at the 3-month term rate (i.e., the spot rate starting at present). Correspondingly, if one desires the 1-year term rate, one compounds the first years' worth of instantaneous forward rates, etc.

As has been described, in some embodiments, a method for generating a short-term interest rate for use in a transaction may comprise the following set of sequence of steps, stages, processes, operations, or functions.

Step or Stage One—acquire or access trade data used to compute short-term rate:
In some embodiments, a rate is computed once a day, at the end of the trading day and trade data is collected daily. The underlying data set is as much as possible comprised of market transactions in senior unsecured bullet securitized debt of all maturities. As examples, these may include Commercial paper (CP), Certificates of Deposit (CD), Corporate Bonds (CB), as well as other such securities. A reason it is desirable that the securities be senior and unsecured is so that they bear the full credit of the underlying corporate entity;
   As mentioned, if one is generating a corporate curve for highly rated bonds, as would be the case for short rates, 3 somewhat widely spaced (in maturity) points are sufficient to establish a fit. If there are not this many reliable data points, then there is no new information on how the market is moving, and there is likely an absence of trading. If there is an absence of trading (even in highly rated corporates), then there is no information on credit spreads. Therefore, in this case it is best to keep things the same, or constant;
In some embodiments, the disclosed method considers only securitized assets to ensure that trading is liquid and represents an arm's length transaction and is not affected by other pricing considerations. For example, un-securitized products, such as specified loans, etc. will trade with a liquidity concession relative to liquid securitized debt. This concession would have to be accounted for before transactions in non-securitized assets could be considered in the same data set with securitized assets. This adjustment process would be cumbersome to perform daily;
The disclosed method considers bullet securities (here a bullet bond is a debt investment whose entire principal value is paid in whole upon maturity rather than amortized across its lifespan and where there are no embedded options) to eliminate the need for additional modeling. Assets that are structured or have embedded options, for example, would require more detailed modeling to be considered in the same data set with bullet securities. This would be a cumbersome process to perform daily;
The input data are the traded universe of bullet senior unsecured corporate bonds, commercial paper, CD's, and other such securities. These are divided up (segmented) as needed for a specific use case by industry and credit rating, or another relevant metric. In addition, transactions of a size below a threshold (and/or above) may be excluded because they may not be representative of active, arm's length transactions;
In general, the more extensive and unbiased the data set, the better for generating a reliable short-rate value. Since CB trades must be reported to the TRACE system of FINRA, these will be universally available to all subscribers of Trace. However, the other categories will not be as readily available. As such, data sets of CP, CD, and other securities may need to be acquired through data partners or other sources;

Step or Stage Two—segment the accessed transaction data into a plurality of sets corresponding to each of a family of short rates, with each rate defined by one or more of a party's rating, an industry, a maturity period, or other similar categories:
In this regard, the proposed (Decameron) Benchmark Short Rates (DBSR) constitute a family of benchmark short rates that are designated by rating, industry, maturity period, or other similar category;
   While many different combinations of rates and industries are possible, an objective of the DBSR is to replace LIBOR. Therefore, one specific use case would be to define the DBSR-Bank-A as a rate that is relevant to transactions involving debt securities of banks that are rated A and above (for example by the S&P rating);
      In this example, only transaction data from A rated and above banks will be considered in the index or rate. Other combinations or filtering operations are, of course, possible;
         For example, DBSR-Insurance-A could be the corresponding A rated and above index for the insurance industry, etc.;
      In general, this step may be used to segregate/segment the data as required for each specific benchmark rate. However, note that there is no segregation according to maturity period at this point. So, for example, the data that are to be used for DBSR-Bank-A will be transactions in A rated and above bank debt of all maturities;
The ability to generate multiple industry specific and rating specific rates provides users with more discrete and useful information for a specific transaction.

Step or Stage Three—aggregate desired transaction data and fit to corporate yield curve:
The transaction data of a given day for a specific DBSR rate, for example, the DBSR-Bank-A, as specified in Step 2, are aggregated. The overall corporate yield curve model is fit to this data to determine any undetermined model parameters (such as the short-term or long-term default model parameters). An assumption is made that transactions from one day can be used in concert to derive a single daily curve. This fitted curve is the benchmark DBSR-Bank-A curve (or other specified rating/industry curve) for the day;
   The risk-free rate curve is fixed once a day by where Treasuries or US interest rates swaps close, as examples. This is independent of anything having to do with corporate bonds. Fitting of the corporate trade data fixes the values of the factors of both the long term and short-term default models, whichever are relevant. This produces the corporate spread curve. Then, the corporate rates curve is determined by adding the risk-free rate curve to the curve of corporate spread(s);
   Since this curve is a representation of the given corporate rate across all maturities, a rate of any desired forwarding or maturity can be inferred from the curve. For example, the benchmark 1 month or 3-month DBSR-Bank-A rate can be computed/determined from the curve by looking at the corresponding part of the curve. The benchmark curves for other relevant rates, for example, the DBSR-Insurance-A rate can be similarly constructed, and a desired maturity rate inferred from the resulting curve.

The disclosed rate or corporate yield curve model may be described as incorporating a “parsimonious” (corporate) spread model. The model determines the spread of a corporate security as a function of the maturity from the end of day risk free rate curve. In one embodiment, the risk-free rate curve is derived from a two-and-a-half factor stochastic interest rate model. In this context, a parsimonious model is a model that has a relatively small number of parameters and degrees of freedom (e.g., more than 1 or 2, but less than 6; 3 or 4 may be optimal for many applications). Therefore, a determination of the curve each day requires only a limited amount of data to be fitted to it.

Typically, something on the order 10 “valid” transactions over the entire yield curve are all that are needed to determine the curve with adequate specificity. Naturally, the more data points that are available the better, and in general there will be more than this minimum size data set available.

As background, if there are three factors to be fit, such as the case with the long-term default, then only three data points may be sufficient. However, if there are only 3 data points, then the representation of the market may not be unbiased or well sampled. More data is preferred, but a minimum to get a properly sampled market based on 3 factors requires something like 3 data points per factor on average, or approximately 10 data points in total.

The accuracy of the disclosed approach can be made more quantitative if one is able to know something about the random selection process that leads to trades in specific securities on a given day. However, this behavior is likely random and unknowable, and if an underlying statistical distribution did exist, it would likely be completely unstable and change over time (an accurate model would require assumptions regarding the mathematical or statistical character of “observations” as well as the characteristics of random sampling applicable to markets).

Because of the small number of required daily transactions for use in determining the parameters of the models, it is unlikely to be the case that there will be insufficient transaction data to reliably fit a curve. Therefore, there is typically no need to include transactions from other days (as in the case of the proposed BSBY index), where conditions can be very different (especially during volatile market environments) in order to have enough transaction data to do what is operationally implemented by the disclosed process.

Note that fitting a curve to determine the DBSR is an important part of the described process. This contrasts with the BSBY index, where for the BSBY index, only data on transactions of instruments with short maturity (a year or less) are included in the curve fitting. The result is that curve fitting adds little to the BSBY process, and instead serves only to average the yields of the relevant data points in the maturity buckets of interest. Therefore, the process of determining BSBY would get essentially the same answer by averaging the yields at the relevant points in the bucket.

In contrast, in embodiments of the disclosed process, the shape of the curve is determined by transaction data across the entire maturity spectrum as well as the characteristics of the curve (such as its shape and behavior) that are specified by the models used. As a result, the determination of the DBSR rate at some maturity depends on the entire curve, not just the few points in the area where the DBSR rate is to be determined.

The transaction short-rate determined by the disclosed process may be used as part of determining a rate for an index, loan, or contract. In one example of an application of the process, previous and current uses of LIBOR are suitable examples of uses for the DBSR. The proposed index can serve as an index or a benchmark short rate for transactions that require such a rate. This includes many types of financial contract where a payment, cash flow, or penalty are referenced to a short rate, including but not limited to personal, commercial, and other types of loans, purchase, or lending contracts, etc.

A set of important and valuable use cases are futures and derivative contracts. The Eurodollar futures are futures contracts based on LIBOR. These contracts have been and are used ubiquitously for a myriad of purposes by the global financial industry, including hedging, speculation, risk taking and hedging in general, capital and balance sheet management, tax strategies, etc. A set of futures contracts constructed in the same way but based off the DBSR can readily be used for all the purposes that Eurodollar futures are used.

LIBOR based interest rate swaps are similarly widespread in use throughout the global financial system. Here as well, DBSR based interest rate swaps can be used in the same ways as LIBOR swaps for the same extensive set of purposes. There is also an extensive collection of more exotic derivatives that either require a short rate to compute cash flows or are somehow otherwise indexed off a short rate. These include more complex swaps, and floating rate asset backed notes and mortgages (both residential and commercial).

As mentioned, a difficulty associated with determining a benchmark short rate is what to do when there is “insufficient” data to accurately determine such a rate in a reliable manner. In the case where there is enough data, the short rate will come out to be essentially the same value no matter what method is used because the data are unambiguously dictating that value. This is expected to be the case much of the time (in some situations, as much as 95% of the time). However, a methodology behind the determination of a short rate should work reliably 100% of the time. In this regard, the proposed methodology is a superior method to address the circumstance where there is “insufficient” data, and where as noted, the other proposed alternative methodologies try to overcome the problem of insufficient data by doing things that make the derived rate unreliable and problematic.

In some embodiments of the disclosed process, the fitted data are from a single day, so the information is contemporaneous, and are indicative of what happens on that day. Further, data across all maturities are used to compose the curve. As a result, in some embodiments, a specific curve fitting model plus the transaction data enables the disclosed techniques to “fill in” when there is insufficient data at the shorter maturity periods to compute an average rate at the maturity desired. In such cases, the disclosed approach ensures that there will be sufficient data to be able to derive benchmark short rates. Embodiments of the disclosed process for generating a short-term rate address the yield curve in its entirety, with the understanding that the yield curve behaves in predictable ways that can be exploited to better and more accurately define short term benchmark rates.

The process for generating one or more short-term rates as disclosed herein frees the process from having to rely upon ad hoc and unintuitive measures when transactional data becomes limited. The process and resulting short-term rates may be licensed and produce the same potential economic value as LIBOR itself. This is because DBS R has the same attractive features as LIBOR (a true credit based short rate), while having none of the shortcomings (with respect to the problems associated with the rate survey and the final determination of the rate) that diminished LIBOR's desirability.

Although the disclosed methodology for generating a short-term interest rate has been described in the context of setting or determining a corporate bond yield rate, the methodology may be used for other purposes. These include one or more of the following:
Spot overnight benchmark index rate: the spot overnight corporate rate can be defined to be a benchmark rate, much as overnight LIBOR or SOFR are today. A benefit of the proposed methodology is that a specification of the corporate yield curve can then be used to generate a forward or future spot rate, and hence forward or future overnight benchmark rates. One reason for this is that the disclosed methodology uses a curve fitting methodology to capture the entire yield curve, and then to infer whatever rate or rates are required off the curve. As such, the proposed overnight benchmark rate represents a possible replacement for overnight LIBOR, and its corresponding applications. It also represents a possible replacement for overnight SOFR because it has a credit component that SOFR lacks;
   Once a yield curve is determined, all types of rates can be computed off the curve, as the yield curve contains the rate information required to build any other rate. A yield curve is basically the instantaneous forward rate at all times; therefore, any rate can be built out of this information by compounding properly;
Term rates (e.g., 1 month, 3-month, 6 months, etc.) computed from the curve also can be used to define term benchmark rates. These can be viable replacements for term LIBOR and all corresponding applications;
Important business uses of benchmark rates include:
   as the index for interest rate swaps, in the same manner as LIBOR or SOFR are currently used;
   as the index for futures contracts, in the same manner as LIBOR futures are used in Eurodollar futures;
   as an index used to compute contractual cash flows on asset backed securities or any type of contract.
      Collectively these applications can be thought of as creating a reference index for derivatives, asset backed securities, and contractual obligations. The economic value of these use cases can be rather variable over time given market conditions and market penetration. However, the massive size of the concerned global markets implies that the eventual economic value is very considerable.

Other potential uses or variations to the examples described include, but are not limited to:
Generating rate curves for countries that do not enjoy sufficiently high credit ratings;
   For example, the sovereign government curves for Mexico, Brazil, Venezuela, China, Vietnam, etc. cannot be dealt with in the same way as for the US, UK, Germany, etc. The high credit quality countries have sovereign curves that are typically considered “risk free” as assumed herein. This is because the credit ratings agencies assign nearly zero probability of default to these securities, and why fitting sovereign curves for the securities issued by these countries does not require a default model;
   However, credit ratings agencies assess that the other countries given as examples listed above do have a non-zero probability of defaulting on their debt securities. Therefore, their sovereign curves will require the default model treatment described herein. The countries that are investment grade will only have long term default, while the below investment grade countries will require both short- and long-term default models;
Debt of states, provinces, municipalities, supranational organizations, and other non-corporate entities that are thought to have non-zero probability of default. This is an extension of country debt securities to sub-country or supra-country debt securities; and
Private label debt or loans. The discussion herein generally limited to securitized credit. However, there is a growing industry in Peer-to-Peer lending (for example) where the loans are not securitized but remain characterized as loans on a balance sheet. With sufficient loan issuance data, curves could potentially be created for these as well using the methodology described herein.

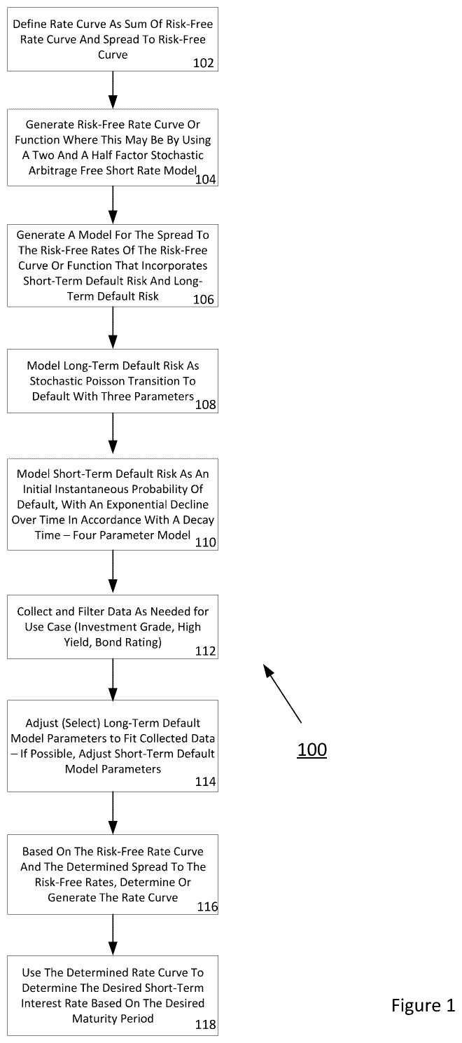

FIG. 1 is a flowchart or flow diagram illustrating a method, process, operation, or function 100 for determining a short-term interest rate, in accordance with some embodiments. As shown in the figure, in one embodiment, the disclosed methodology may include the following steps or stages:
Define (Corporate) Rate Curve As Sum Of Risk-Free Rate Curve And (Corporate) Spread To Risk-Free Curve (As Suggested By Step or Stage 102);
Generate Risk-Free Rate Curve Or Function (Step or Stage 104);
   In one embodiment, this may be by using a Two And A Half Factor Stochastic Arbitrage Free Short Rate Model;
Generate a Model For The (Corporate) Spread To The Risk-Free Rates Of The Risk-Free Curve Or Function That Incorporates Short-Term Default Risk And Long-Term Default Risk (Step or Stage 106);
   Model Long-Term Default Risk As Stochastic Poisson Transition To Default With Three Parameters (Step or Stage 108);
   Model Short-Term Default Risk As An Initial Instantaneous Probability Of Default, With An Exponential Decline Over Time In Accordance With A Decay Time—A Four Parameter Model (Step or Stage 110);
Collect And Filter Data As Needed For Use Case (Investment Grade Or High Yield) (Step or Stage 112);
Adjust (Set, Determine, Select) Long-Term Default Model Parameters To Collected Data—If Possible, Adjust Short-Term Default Model Parameters (Step or Stage 114);
Based On The Risk-Free Rate Curve And The Determined (Corporate) Spread To The Risk-Free Rates, Determine Or Generate The Rate (Corporate Yield) Curve (Step or Stage 116);
Use The Determined Rate (Corporate Yield) Curve To Determine The Desired Short-Term Interest Rate Based On The Maturity Period (Step or Stage 118).

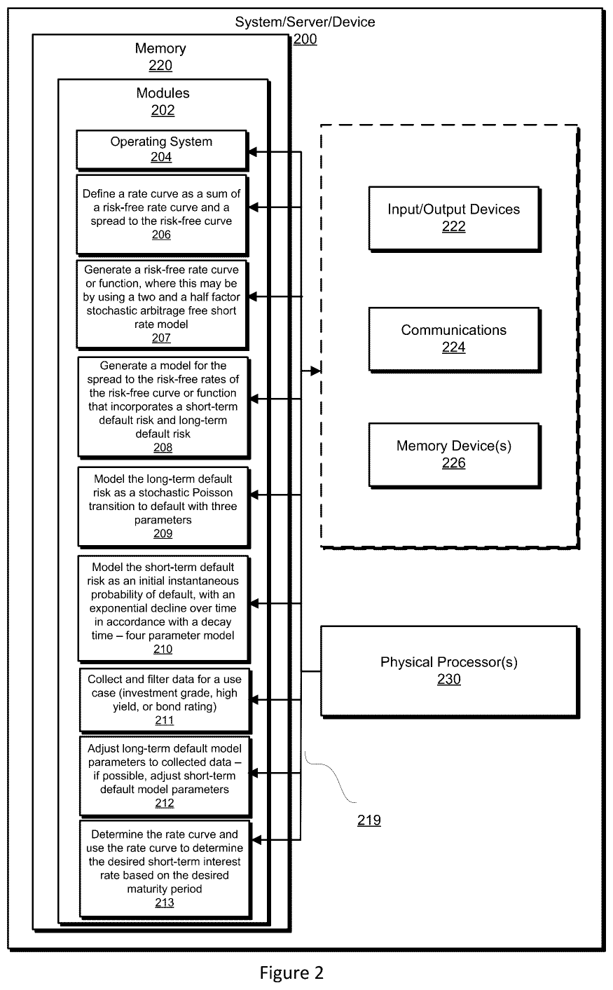

FIG. 2 is a diagram illustrating elements or components that may be present in a computer device, server, or system 200 configured to implement a method, process, function, or operation in accordance with some embodiments. As noted, in some embodiments, the described system and methods may be implemented in the form of an apparatus that includes a processing element and set of executable instructions. The executable instructions may be part of a software application and arranged into a software architecture. In general, an embodiment of the invention may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent a server or other form of computing or data processing device. Modules 202 each contain a set of executable instructions, where when the set of instructions is executed by a suitable electronic processor (such as that indicated in the figure by “Physical Processor(s) 230”), system (or server or device) 200 operates to perform a specific process, operation, function, or method. Modules 202 may contain one or more sets of instructions for performing a method or function described with reference to the Figures, and the descriptions of the functions and operations provided in the specification. These modules may include those illustrated but may also include a greater number or fewer number than those illustrated. Further, the modules or the computer-executable instructions that are contained in the modules may be executed (in whole or in part) by the same processor or by more than a single processor.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing a set of instructions. Bus or communications line 216 also permits processor(s) 230 to interact with other elements of system 200, such as input or output devices 222, communications elements 224 for exchanging data and information with devices external to system 200, and additional memory devices 226.

Each application module or sub-module may correspond to a specific function, method, process, or operation that is implemented by the module or sub-module. Each module or sub-module may contain a set of computer-executable instructions that when executed (in whole or in part) by a programmed processor or co-processors cause the processor or co-processors (or a server, platform, apparatus, or device in which they are contained) to perform the specific function, method, process, or operation. Such function, method, process, or operation may include those used to implement one or more aspects of the disclosed system and methods, such as for:
Defining a (corporate) rate curve as a sum of a risk-free rate curve and a (corporate) spread to the risk-free curve (as suggested by module 206);
   If the methodology is to be applied to generate a different type of curve or transaction model, then the curve may be defined as the sum of a baseline curve and a spread to that curve representing the deviation from the baseline for the overall curve or model;
Generating a risk-free rate curve or function (module 207);
   In one embodiment, this may be by using a two and a half factor stochastic arbitrage free short rate model;
   Depending upon the type of curve being generated, the baseline may be of a different type or model (i.e., other than a risk-free rate curve);
Generating a model for the (corporate) spread to the risk-free rates of the risk-free curve or function that incorporates a short-term default risk and long-term default risk (module 208);
   As with the baseline model, depending upon the type of curve being generated, the spread or deviation model may take a different form or have different components;
Modeling the long-term default risk as a stochastic Poisson transition to default with three parameters (module 209);
Modeling the short-term default risk as an initial instantaneous probability of default, with an exponential decline over time in accordance with a decay time—a four parameter model (module 210);
Collecting and filtering data as needed for a use case (investment grade, high yield, or bond rating) (module 211);
Adjusting (select) long-term default model parameters to collected data—if possible, adjust short-term default model parameters (module 212);
Based on the risk-free rate curve and the determined (corporate) spread to the risk-free rates, determining or generating the rate (corporate yield) curve (module 213);
Using the determined rate (corporate yield) curve to determine the desired short-term interest rate based on the maturity period (module 213).

As mentioned, each module may contain instructions which when executed by a programmed processor cause an apparatus (such as a server or client device) to perform the specific function or functions. The apparatus may be one or both of a client device or a remote server or platform. Therefore, a module may contain instructions that are performed (in whole or in part) by the client device, the server or platform, or both.

In some embodiments, an application downloaded to a client device or a plug-in to a device's browser or operating system may enable a user desiring a short-term rate to contact a remote server platform and request that such a rate be generated. This may cause the server platform to access data available from trading and implement the disclosed method to generate a short-term rate which is then provided to the user. In another embodiment or implementation, a user may access a downloaded application or plug-in, navigate to a website, and request a short-term rate. In response, a server platform may access trading data, provide that to the client device, and then the application or plug-in may generate the requested short-term rate.

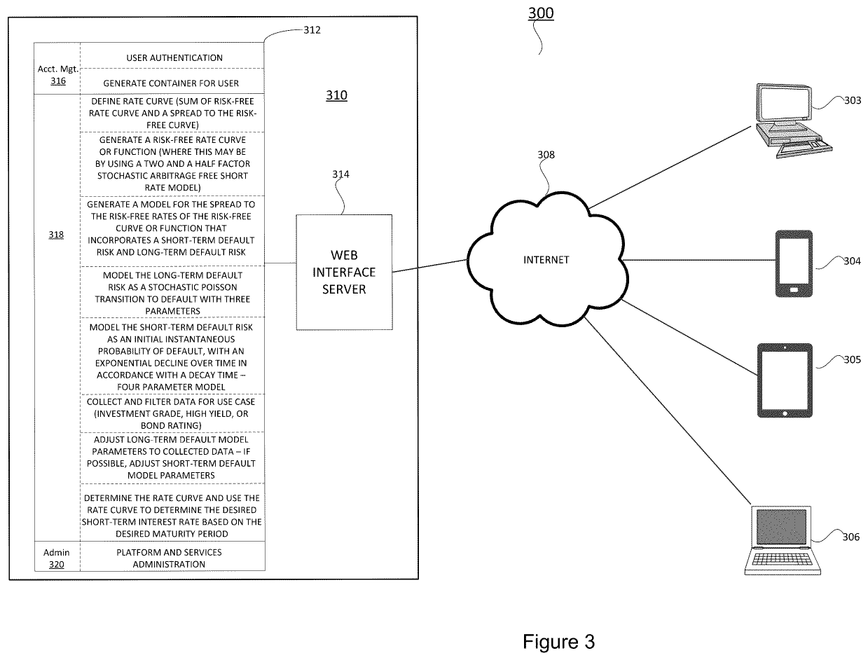

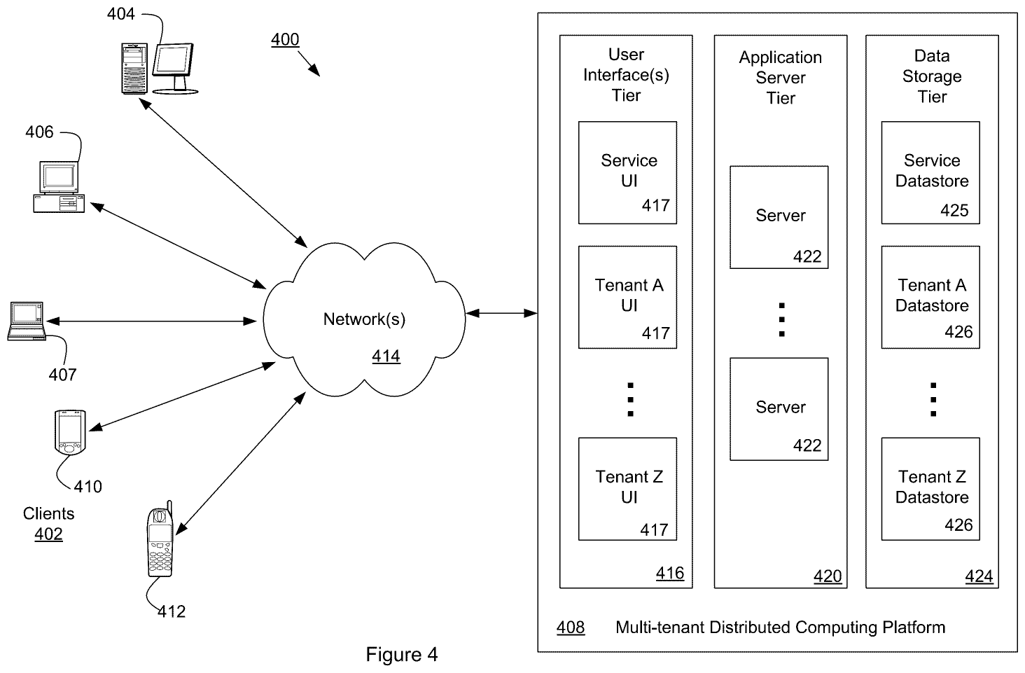

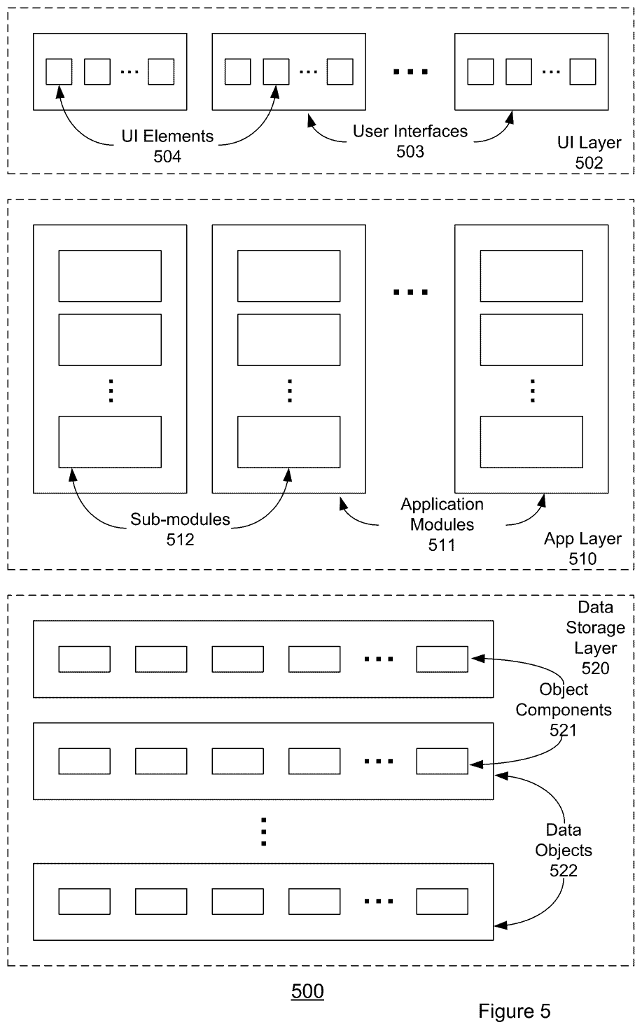

In some embodiments, the functionality and services provided by the system and methods described herein may be made available to multiple users by accessing an account maintained by a server or service platform. Such a server or service platform may be termed a form of Software-as-a-Service (SaaS). FIG. 3 is a diagram illustrating a SaaS system in which an embodiment of the invention may be implemented. FIG. 4 is a diagram illustrating elements or components of an example operating environment in which an embodiment of the invention may be implemented. FIG. 5 is a diagram illustrating additional details of the elements or components of the multi-tenant distributed computing service platform of FIG. 4, in which an embodiment of the invention may be implemented.

In some embodiments, the system or services described herein may be implemented as micro-services, processes, workflows, or functions performed in response to the submission of a request from a user or event generated by a data processing flow. The micro-services, processes, workflows, or functions may be performed by a server, data processing element, platform, or system. In some embodiments, the services may be provided by a service platform located “in the cloud”. In such embodiments, the platform is accessible through APIs and SDKs. The services may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the data processing services to generate a short-term rate, such as those described herein. Although in some embodiments, a platform or system of the type illustrated in FIGS. 3-5 may be operated by a 3^{rd} party provider to provide a specific set of business-related applications, in other embodiments, the platform may be operated by a provider and a different business may provide the applications or services for users through the platform.

FIG. 3 is a diagram illustrating a system 300 in which an embodiment of the invention may be implemented or through which an embodiment of the services described herein may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, smartphones, etc. In general, any client device having access to the Internet may be used to submit a request to the platform to initiate the generation of a short-term rate. Users interface with the service platform across the Internet 312 or another suitable communications network or combination of networks. Examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. It is to be appreciated that either or both of the data processing services 312 and web interface server 314 may be implemented on one or more different hardware systems and components, even though represented as singular units in FIG. 3. Services 312 may include one or more functions or operations for receiving a user's request and in response providing the user with a short-term rate.

As examples, in some embodiments, the set of applications, functions, operations or services made available through the platform or system 310 may include:
account management services 316, such as
   a process or service to authenticate a user;
   a process or service to receive a request for processing data to generate a short-term rate;
   a process or service to generate a container or instantiation of the processing and processes; or
   other forms of account management services.
processes or services 318, such as
   a process or service to define a (corporate) rate curve (e.g., a sum of risk-free rate curve and a spread to the risk-free curve);
   a process or service to generate a risk-free rate curve or function;
      in one embodiment, this may be based on a two and a half factor stochastic arbitrage free short rate model;
   a process or service to generate a model for the spread to the risk-free rates of the risk-free curve or function that incorporates a short-term default risk and long-term default risk;
   process or service to model the long-term default risk as a stochastic Poisson transition to default with three parameters;
   a process or service to model the short-term default risk as an initial instantaneous probability of default, with an exponential decline over time in accordance with a decay time (a four-parameter model);
   a process or service to collect and filter data for a use case (e.g., investment grade, high yield, or bond rating);
   a process or service to adjust long-term default model parameters to collected data—if possible, adjust short-term default model parameters; and
   a process or service to determine the rate (corporate yield) curve and use the rate curve to determine the desired short-term interest rate based on the desired maturity period;
administrative services 320, such as
   a process or services to enable the provider of the method of generating a short-term rate and/or the platform to administer and configure the processes and services provided to a user, etc.

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment of the invention may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data processing described herein) are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment of the invention may be implemented. The software architecture shown in FIG. 5 represents an example of an architecture which may be used to implement an embodiment of the invention. In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment of the invention may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the inventive system and methods, such as for one or more of the processes or functions described with reference to the Figures.

In some embodiments, these processes or functions may include:
Defining a (corporate) rate curve as a sum of a risk-free rate curve and a (corporate) spread to the risk-free curve;
   If the methodology is to be applied to generate a different type of curve or transaction model, then the curve may be defined as the sum of a baseline curve and a spread to that curve representing the deviation from the baseline for the overall curve or model;
Generating a risk-free rate curve or function;
   In one embodiment, this may be generated using a two and a half factor stochastic arbitrage free short rate model;
   Depending upon the type of curve being generated, the baseline may be of a different type or model (i.e., other than a risk-free rate curve);
Generating a model for the corporate spread to the risk-free rates of the risk-free curve or function that incorporates a short-term default risk and long-term default risk;
   As with the baseline model, depending upon the type of curve being generated, the spread or deviation model may take a different form or have different components;
Modeling the long-term default risk as a stochastic Poisson transition to default with three parameters;
Modeling the short-term default risk as an initial instantaneous probability of default, with an exponential decline over time in accordance with a decay time—a four-parameter model;
Collecting and filtering data as needed for a use case (e.g., investment grade, high yield, or bond rating);
Adjusting (select) long-term default model parameters to collected data—if possible, adjust short-term default model parameters;
Based on the risk-free rate curve and the determined (corporate) spread to the risk-free rates, determining or generating the rate (corporate yield) curve; and
Using the determined rate curve to determine the desired short-term interest rate based on the maturity period.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

This disclosure includes the following embodiments and clauses:

1. A method of determining an interest rate for a transaction, comprising:
defining a rate curve as a sum of a risk-free rate curve and a spread to the risk-free rate curve;
generating a risk-free rate curve;
generating a model for the spread to the risk-free rate curve that incorporates a long-term default risk;
modeling the long-term default risk as a stochastic Poisson transition to a default with three parameters;
collecting and filtering trade data as needed for a use case;
adjusting the long-term default risk model parameters to the collected and filtered data;
based on the risk-free rate curve and the determined spread to the risk-free rate curve, determining or generating the rate curve; and
using the determined or generated rate curve to determine the desired short-term interest rate for the transaction based on the maturity period.
   2. The method of clause 1, wherein the model for the spread to the risk-free rate curve further incorporates a short-term default risk.
   3. The method of clause 2, wherein the short-term default risk is modeled as an initial instantaneous probability of default, with an exponential decline over time in accordance with a decay time.
   4. The method of clause 1, wherein the trade data corresponds to a range of maturity periods.
   5. The method of clause 4, wherein the trade data is filtered to select data for a specific rating or industry.
   6. The method of clause 1, wherein the use case is investment grade or high yield.
   7. The method of clause 3, further comprising adjusting the short-term default risk model parameters to the collected and filtered data.
   8. The method of clause 1, wherein the risk-free rate curve is generated using a two and a half factor stochastic arbitrage free short rate model, and parameters for the two and a half factor model further comprise:
a first factor representing the long-term equilibrium behavior of rates as the compounding of overnight rates;
a second factor representing intermediate term deviations from the long-term equilibrium and that is characterized by a second independent volatility and a rate of decay back to the long-term equilibrium level; and
a third half-factor that characterizes short-term deviations from the medium-term deviations of rates, and where this factor decays to the intermediate term deviations over a specific timescale.
   9. A system, comprising:
one or more electronic processors configured to execute a set of computer-executable instructions; and
one or more non-transitory electronic data storage media containing the set of computer-executable instructions, wherein when executed, the instructions cause the one or more electronic processors to
   define a rate curve as a sum of a risk-free rate curve and a spread to the risk-free rate curve;
   generate a risk-free rate curve;
   generate a model for the spread to the risk-free rate curve that incorporates a long-term default risk;
   model the long-term default risk as a stochastic Poisson transition to a default with three parameters;
   collect and filter trade data as needed for a use case;
   adjust the long-term default risk model parameters to the collected and filtered data;
   based on the risk-free rate curve and the determined spread to the risk-free rate curve, determine or generate the rate curve; and
   use the determined or generated rate curve to determine the desired short-term interest rate for the transaction based on the maturity period.
      10. The system of clause 9, wherein the model for the spread to the risk-free rate curve further incorporates a short-term default risk.
      11. The system of clause 10, wherein the short-term default risk is modeled as an initial instantaneous probability of default, with an exponential decline over time in accordance with a decay time.
      12. The system of clause 9, wherein the trade data corresponds to a range of maturity periods.
      13. The system of clause 11, wherein the short-term default risk model parameters are adjusted to the collected and filtered data.
      14. The system of clause 9, wherein the risk-free rate curve is generated using a two and a half factor stochastic arbitrage free short rate model, and parameters for the two and a half factor model further comprise:
a first factor representing the long-term equilibrium behavior of rates as the compounding of overnight rates;
a second factor representing intermediate term deviations from the long-term equilibrium and that is characterized by a second independent volatility and a rate of decay back to the long-term equilibrium level; and
a third half-factor that characterizes short-term deviations from the medium-term deviations of rates, and where this factor decays to the intermediate term deviations over a specific timescale.
   15. One or more non-transitory computer-readable media comprising a set of computer-executable instructions that when executed by one or more programmed electronic processors, cause the processors to:
define a rate curve as a sum of a risk-free rate curve and a spread to the risk-free rate curve;
generate a risk-free rate curve;
generate a model for the spread to the risk-free rate curve that incorporates a long-term default risk;
model the long-term default risk as a stochastic Poisson transition to a default with three parameters;
collect and filter trade data as needed for a use case;
adjust the long-term default risk model parameters to the collected and filtered data;
based on the risk-free rate curve and the determined spread to the risk-free rate curve, determine or generate the rate curve; and
use the determined or generated rate curve to determine the desired short-term interest rate for the transaction based on the maturity period.
   16. The one or more non-transitory computer-readable media of clause 15, the model for the spread to the risk-free rate curve further incorporates a short-term default risk.
   17. The one or more non-transitory computer-readable media of clause 16, wherein the short-term default risk is modeled as an initial instantaneous probability of default, with an exponential decline over time in accordance with a decay time.
   18. The one or more non-transitory computer-readable media of clause 15, wherein the trade data corresponds to a range of maturity periods.
   19. The one or more non-transitory computer-readable media of clause 17, wherein the short-term default risk model parameters are adjusted to the collected and filtered data.
   20. The one or more non-transitory computer-readable media of clause 15, wherein the risk-free rate curve is generated using a two and a half factor stochastic arbitrage free short rate model, and parameters for the two and a half factor model further comprise:
a first factor representing the long-term equilibrium behavior of rates as the compounding of overnight rates;
a second factor representing intermediate term deviations from the long-term equilibrium and that is characterized by a second independent volatility and a rate of decay back to the long-term equilibrium level; and
a third half-factor that characterizes short-term deviations from the medium-term deviations of rates, and where this factor decays to the intermediate term deviations over a specific timescale.
   21. The system of clause 9, wherein the trade data is filtered to select data for a specific rating or industry.
   22. The system of clause 9, wherein the use case is investment grade or high yield.
   23. The one or more non-transitory computer-readable media of clause 15, wherein the trade data is filtered to select data for a specific rating or industry.
   24. The one or more non-transitory computer-readable media of clause 15, wherein the use case is investment grade or high yield.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method of determining an interest rate for a transaction, comprising:
defining a rate curve as a sum of a risk-free rate curve and a spread to the risk-free rate curve;
generating a risk-free rate curve;
generating a model for the spread to the risk-free rate curve that incorporates a long-term default risk;
modeling the long-term default risk as a stochastic Poisson transition to a default with three parameters;
collecting and filtering trade data as needed for a use case;
adjusting the long-term default risk model parameters to the collected and filtered data;
based on the risk-free rate curve and the determined spread to the risk-free rate curve, determining or generating the rate curve; and
using the determined or generated rate curve to determine the desired short-term interest rate for the transaction based on the maturity period.

2. The method of claim 1, wherein the model for the spread to the risk-free rate curve further incorporates a short-term default risk.

3. The method of claim 2, wherein the short-term default risk is modeled as an initial instantaneous probability of default, with an exponential decline over time in accordance with a decay time.

4. The method of claim 1, wherein the trade data corresponds to a range of maturity periods.

5. The method of claim 4, wherein the trade data is filtered to select data for a specific rating or industry.

6. The method of claim 1, wherein the use case is investment grade or high yield.

7. The method of claim 3, further comprising adjusting the short-term default risk model parameters to the collected and filtered data.

8. The method of claim 1, wherein the risk-free rate curve is generated using a two and a half factor stochastic arbitrage free short rate model, and parameters for the two and a half factor model further comprise:
a first factor representing the long-term equilibrium behavior of rates as the compounding of overnight rates;
a second factor representing intermediate term deviations from the long-term equilibrium and that is characterized by a second independent volatility and a rate of decay back to the long-term equilibrium level; and
a third half-factor that characterizes short-term deviations from the medium-term deviations of rates, and where this factor decays to the intermediate term deviations over a specific timescale.

9. A system, comprising:
one or more electronic processors configured to execute a set of computer-executable instructions; and
one or more non-transitory electronic data storage media containing the set of computer-executable instructions, wherein when executed, the instructions cause the one or more electronic processors to
define a rate curve as a sum of a risk-free rate curve and a spread to the risk-free rate curve;
generate a risk-free rate curve;
generate a model for the spread to the risk-free rate curve that incorporates a long-term default risk;
model the long-term default risk as a stochastic Poisson transition to a default with three parameters;
collect and filter trade data as needed for a use case;
adjust the long-term default risk model parameters to the collected and filtered data;
based on the risk-free rate curve and the determined spread to the risk-free rate curve, determine or generate the rate curve; and
use the determined or generated rate curve to determine the desired short-term interest rate for the transaction based on the maturity period.

10. The system of claim 9, wherein the model for the spread to the risk-free rate curve further incorporates a short-term default risk.

11. The system of claim 10, wherein the short-term default risk is modeled as an initial instantaneous probability of default, with an exponential decline over time in accordance with a decay time.

12. The system of claim 9, wherein the trade data corresponds to a range of maturity periods.

13. The system of claim 11, wherein the short-term default risk model parameters are adjusted to the collected and filtered data.

14. The system of claim 9, wherein the risk-free rate curve is generated using a two and a half factor stochastic arbitrage free short rate model, and parameters for the two and a half factor model further comprise:
a first factor representing the long-term equilibrium behavior of rates as the compounding of overnight rates;
a second factor representing intermediate term deviations from the long-term equilibrium and that is characterized by a second independent volatility and a rate of decay back to the long-term equilibrium level; and
a third half-factor that characterizes short-term deviations from the medium-term deviations of rates, and where this factor decays to the intermediate term deviations over a specific timescale.

15. One or more non-transitory computer-readable media comprising a set of computer-executable instructions that when executed by one or more programmed electronic processors, cause the processors to:
define a rate curve as a sum of a risk-free rate curve and a spread to the risk-free rate curve;
generate a risk-free rate curve;
generate a model for the spread to the risk-free rate curve that incorporates a long-term default risk;
model the long-term default risk as a stochastic Poisson transition to a default with three parameters;
collect and filter trade data as needed for a use case;
adjust the long-term default risk model parameters to the collected and filtered data;
based on the risk-free rate curve and the determined spread to the risk-free rate curve, determine or generate the rate curve; and
use the determined or generated rate curve to determine the desired short-term interest rate for the transaction based on the maturity period.

16. The one or more non-transitory computer-readable media of claim 15, the model for the spread to the risk-free rate curve further incorporates a short-term default risk.

17. The one or more non-transitory computer-readable media of claim 16, wherein the short-term default risk is modeled as an initial instantaneous probability of default, with an exponential decline over time in accordance with a decay time.

18. The one or more non-transitory computer-readable media of claim 15, wherein the trade data corresponds to a range of maturity periods.

19. The one or more non-transitory computer-readable media of claim 17, wherein the short-term default risk model parameters are adjusted to the collected and filtered data.

20. The one or more non-transitory computer-readable media of claim 15, wherein the risk-free rate curve is generated using a two and a half factor stochastic arbitrage free short rate model, and parameters for the two and a half factor model further comprise:
a first factor representing the long-term equilibrium behavior of rates as the compounding of overnight rates;
a second factor representing intermediate term deviations from the long-term equilibrium and that is characterized by a second independent volatility and a rate of decay back to the long-term equilibrium level; and
a third half-factor that characterizes short-term deviations from the medium-term deviations of rates, and where this factor decays to the intermediate term deviations over a specific timescale.
